(19) United States
(12) Patent Application Publication
(10) Pub. No.: US 2010/0021221 A1
(43) Pub. Date: Jan. 28, 2010

(54) Process For Manufacturing A Paperboard Key Card

(76) Inventor: Wade Bryant, Charlotte, NC (US)

Correspondence Address: ST. ONGE STEWARD JOHNSTON & REENS, LLC, 986 BEDFORD STREET, STAMFORD, CT, 06905-5619, US

(21) Appl. No.: 12/179,153

(22) Filed: Jul. 24, 2008

(51) Int. Cl. B41J 5/30

(52) U.S. Cl. 400/61

(57) ABSTRACT

The present invention pertains to a system and method for manufacturing paperboard key cards. The invention involves feeding a continuous paper web into a system that prints a pattern of insignia upon the web, and also stamps a magnetic stripe onto the web in a periodic manner. The web passes through a dicer, which cuts the cards out of the web via a patterned die. The cards are then sent to a conveyor to be stacked and packaged, while the remaining web is directed in a direction divergent from the card flow.

### FIELD OF THE INVENTION

The present invention pertains to a system and method for manufacturing paperboard key cards. The invention involves feeding a continuous paper web into a system that prints a pattern of insignia upon the web. The web passes through a dicer, which cuts cards out of the web via a patterned die. Upon cutting the cards out from the web, the cards are separated from the web via rollers which shoot the cards out onto a conveyor belt. The remaining web is directed in a divergent direction from the cards and sent for removal.

### BACKGROUND OF THE INVENTION

In hotels and other establishments where the user is to be given temporary access to a room or other venue, technology has shifted away from using standard key technology to gain access to a closed room. Keys, which are often bulky, expensive, and hard to replace, are being replaced by cards containing a magnetically encoded stripe. It is upon this magnetic stripe that temporary information is coded, so the card can be used to access a locked room or other venue. Cards are typically made out of plastic, which is a rather durable, but unfriendly material for the environment.

Cards are now also made from recyclable paper, which is more environmentally sound, as well as less costly than plastic. Paper cards promote a “single visit” concept, whereby cards are used once and are not expected to be returned. Paper cards are more sanitary as the cards are not passed through multiple users, as a plastic card typically would be. Furthermore, despite requests to return plastic cards, often plastic cards are destroyed rather than returned for subsequent use.

Previous methods of manufacturing such paper cards utilized a number of separate manufacturing steps. U.S. Pat. No. 6,152,029 discloses a method whereby a paper card is printed and magnetically encoded via an in-line process. The patent discloses the synchronization of printing and magnetic coding and makes reference to a system that contains an image synchronization controller that monitors speed and location of the web for purposes of controlling a printer. The controller unit also monitors a magnetic encoder, which reads both printed and magnetically encoded information.

The present invention does not monitor speed and location to control a printer and magnetic encoder during the process of manufacturing paper cards. This saves upon cost as the present invention does not require extraneous speed and location controls. Instead, the present invention improves upon the method of printing and encoding a paper card by including a patterned die that cuts equal-sized cards during the die cutting step, and separates the web from the cards by turning the web at a direction divergent from the card stream, so that the web is sent for removal and the cards are directed out onto a conveyor where they are shingled and packaged.

### SUMMARY OF THE INVENTION

The present invention involves a process for manufacturing a plurality of cards from a web, through the use of an in-line process, whereby the web is printed and magnetically encoded, diced via a patterned die into cards, whereby the web is separated from the cards by turning the web in a direction divergent from the card stream. The cards are sent out onto a conveyor for packaging, and the web is sent at a divergent direction for removal, and/or shredding.

The invention involves loading a continuous paper web into a system. The web moves via tension through the system, where it is first sent though a printer to print upon the front side. The web is then optionally turned and magnetic stripes are applied to the back side of the card via a hot foil stamping unit. Printing also can occur upon the back of the card, and the sequence in which printing and application of the magnetic strip are performed vary upon the type of printing required.

A coating is then optionally applied over the web and the web is the moved to a separate die cutting unit that dices the web into cards via a patterned die. The patterned die is designed so that the cards are cut in a pattern creating cards of equal size, and does not require a controller that monitors speed and location of the web for purposes of cutting equal sized cards, such as required by the prior art.

The web-card matrix is then separated whereby the cards are separated from the web by turning the web and waste flow in a direction divergent from the card stream, and the web is sent into a removal or shredding device. Meanwhile, the remaining cards continue to move in their original linear direction and are directed out via several rollers onto a conveyor or slide. As the cards are directed out onto the conveyer, the cards are shingled, and stacked into boxes by hand.

The mechanism for turning the web and waste flow in a direction divergent from the card stream involves pulling the web flow in a direction divergent from the cards. An optimal direction is approximately ninety degrees from the card flow. This allows for efficient separation of the cards from the web as the web is turned and the proximal end of the card can be grasped by the friction of a roller or conveyor. This allows the cards to continue in their original planar direction without damaging the cards.

It is the object of the invention to provide a system and method to produce, in a continuous in-line fashion, magnetically encoded paper cards with printed insignia whereby the printed cards are cut via a patterned die and conveyed into a straight line for manual stacking, while the remaining waste and web flow is rotated in a direction divergent from the card stream and sent for removal.

It is another embodiment of the invention to provide a mechanism for turning the web and waste flow in a direction divergent from the card stream whereby a roller is positioned so it periodically touches the web, but not the cards. Upon touching the web, the tension of the touching causes the web to get pulled through in a direction divergent from the card stream. The cards, which are not touched, continue to move in their original direction, and are sent onto the conveyor. The rollers allow the cards to be directed out onto the conveyor without bending or damaging the cards.

It is another embodiment of this invention to produce thin cards of a thickness of approximately 0.25 inches, as this thickness of cards is beneficial both for the production of cards as well as for storing cards in a person's wallet.

The system and method of this invention involves making paper cards for use in temporary permits and identification, gift certificates, membership and affinity cards and the like. Another object of the invention is to provide a card to permit activation after purchase, though passing the magnetic strip of the card through a reader at the point of sale, and to provide a method to capture customer information, track marketing efforts and generate instant customer data all relating to information stored or printed on the card.

### BRIEF DESCRIPTION OF THE DRAWINGS

The process for manufacturing a paperboard key card, which is the subject of the invention, is explained in detail by means of the following drawings which represent the examples of the realization, not implying any limitation to construction and embodiment of the said device.

FIG. 1 shows a schematic drawing of the card manufacturing process sequence of one embodiment of the present invention.

FIG. 2 is a plain view illustrating the printing and encoding on a completed card of one embodiment of the present invention.

FIG. 3 is a plain view illustrating the printing and encoding on the other side of a completed card of one embodiment of the present invention, including a magnetic stripe applied onto the card via a hot foil stamping unit.

FIG. 4 is a block diagram of the process sequence steps of an embodiment of the present invention.

FIG. 5 illustrates a view of the cards intertwined with the web after dicing, but before separation from the web.

FIG. 6 is another embodiment the card manufacturing sequence is shown with periodic touching of the web to create only tension on the web, not the cards, forcing the web in a direction divergent from the card flow.

### DETAILED DESCRIPTION OF THE INVENTION

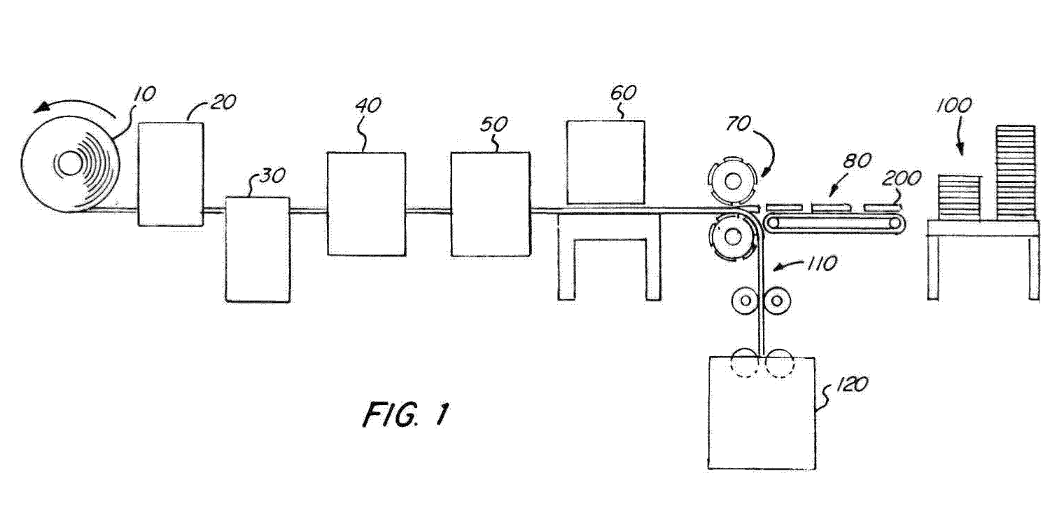

As shown in the schematic drawing illustrating the overall manufacturing sequence in FIG. 1, a supply roll 10 supplies blank paper card stock in a continuous web having a front side 14 and a back side 15. The ability to use a continuous web in an in-line process is an advantage provided by the present invention. After being unwound from the roll, the web is printed by printing unit 20 where fixed presentation graphics and text are printed onto the front side 14.

The web is then optionally rotated such that the web is then sent to printing unit 30, which prints non-variable printed text and graphics to the backside 15 of the card. In another embodiment, the web is not rotated and rather the printer 30 is located underneath the web, such that printing can occur on the backside 15 of the web.

A pre-manufactured stripe 45 of low or high coercivity magnetic media is unwound from a supply roll 55 and is applied to the back 15 of the web. The stripe 45 has a backing that is fixed to the card stock by a conventional hot stamp unit 40. One, two or three tracks of encoded data are written on the stripe 45. The magnetic stripe may also be encoded with data or other specific information.

Optionally, a coating 65 is applied to both sides of the web to fix the printing and enhance the appearance of the card. This is done via press 50 which applies the clear coating. In one embodiment of the invention, the clear coating is varnish, but other coatings may also be used.

The web is then sent to the patterned die cutter 60, which cuts the web into individual cards 200. The web/card mixture is cut in a specific way such that the cards are cut uniformly and waste is spread out uniformly throughout the web. An optional stripping unit (not shown) is used to make sure that not web based by-product remains on the cards. The web-card mixture is then sent to a separation unit whereby tension pulls the web in a direction 110 divergent from the card flow 70. The card flow is directed out via rollers 80 onto a conveyor 90 such that the cards are placed upon the conveyor and are stacked in a pile 100. The cards are then sent to be packaged either by machinery or by hand.

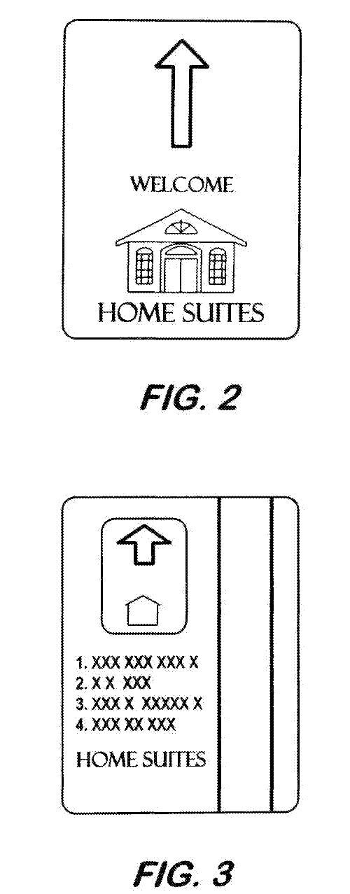

Examples of cards produced by the present invention are shown in FIGS. 2 and 3. FIG. 2 illustrates one side of the card with the inclusion of text 300, and printed insignia 310. FIG. 3 illustrates the backside of the card with text 300 and magnetic stripe 45.

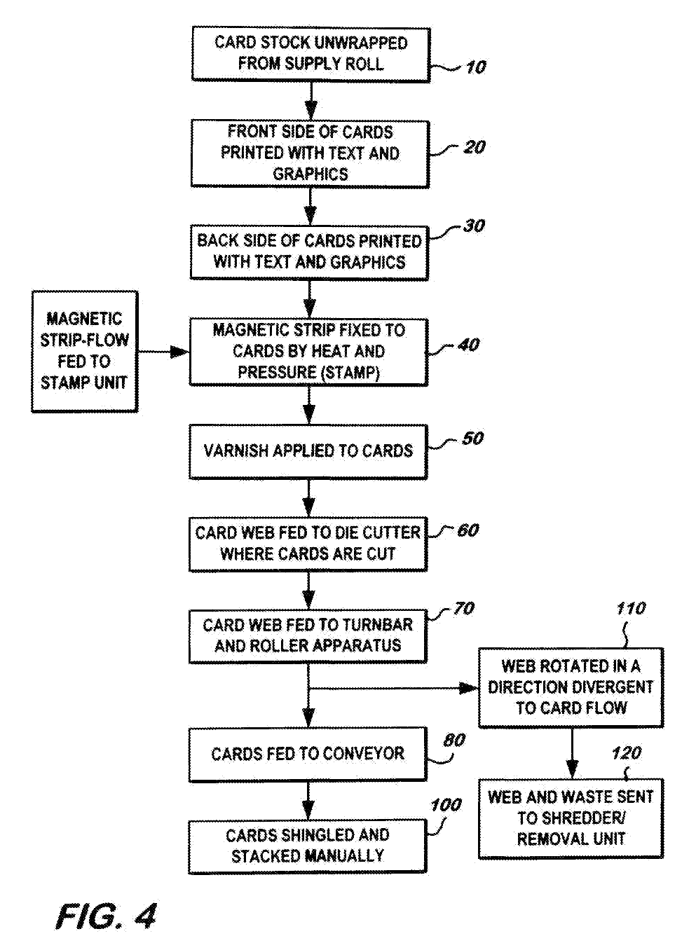

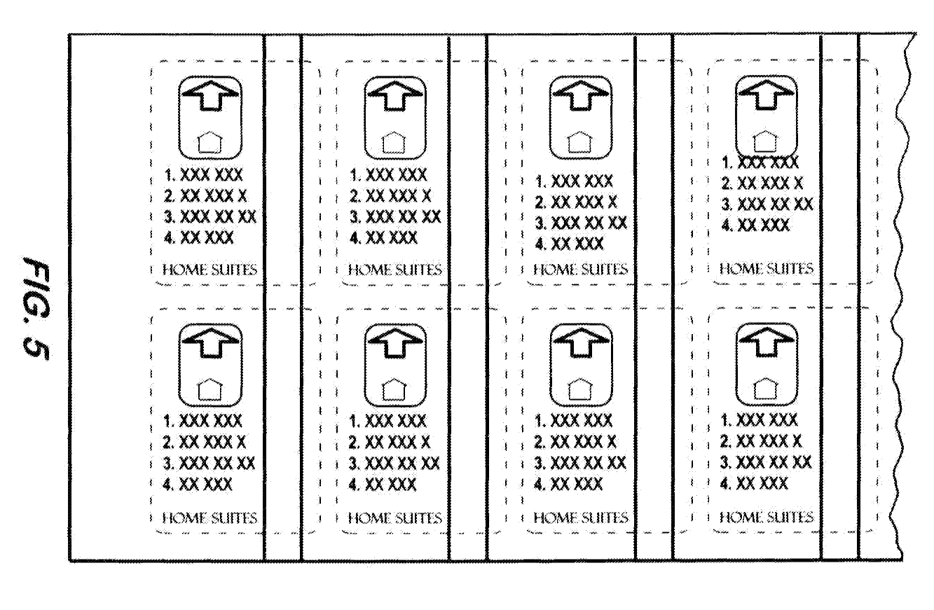

As shown in FIG. 4, the process of manufacturing the magnetic card begins when card stock is unwound from a supply roll 500. The front side of the card is printed by a printer unit 510 and the backside is printed with variable text by a second printer 520.

A magnetic stripe is affixed to the card back by a hot stamp process 530 fed by a magnetic stripe flow 525. Optionally, a clear coating, preferably varnish, is applied to the card at 540. The web is then sent to the patterned die cutter 550, which cuts the web into individual cards 200. The web-card mixture is cut in a specific way such that the cards are cut uniformly and waste is spread out uniformly throughout the web. The card and web mixture is then sent to a separation unit whereby a tension and roller system separates the web 570 from the card flow 580. As the web 570 is pulled it gets pulled in a direction divergent from the direction of the cards. The card flow 580 is directed out via rollers onto a conveyor such that the cards are placed upon the conveyor and are singled 590 and sent to be packaged. The web and waste is sent to a shredder 600 for removal.

FIG. 5 illustrates another embodiment of the web matrix 800 with cut cards 810 still located in the web. The web 820 contains the waste that is sent to the shredder for removal.

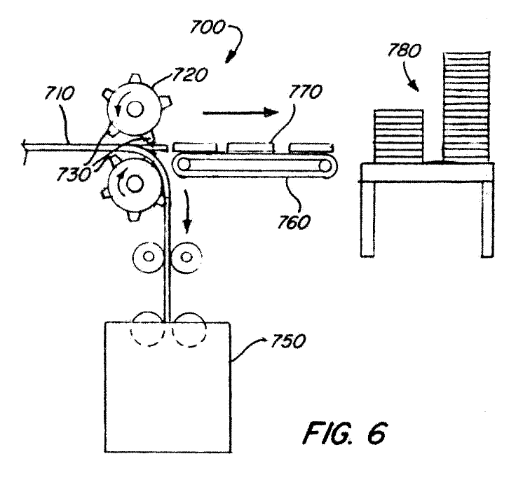

FIG. 6 shows another embodiment whereby the web and card mixture is sent into the separation unit 700. In this embodiment, there is periodic touching of the web 710 so that only the web makes direct contact with the rollers 720 via a small contact surface 730 that is connected to the rollers and periodically makes contact with the web 710. This creates a tension force whereby the tension is only directed towards the web 710 and not the cards 770. The tension causes the cause the web 710 to change direction in a direction divergent from the direction of the cards, so that the web 710 is sent for removal to a shredder 750. The cards on the other hand, continue in the linear direction in which they were travelling and are directed by the rollers 720 out onto a conveyor belt 760. The conveyor belt 760 then sends the cards to be stacked 780.

Other embodiments have more than the two rollers shown in FIGS. 1 and 6. These additional rollers are used to create tension and frictionally draw the web in a direction divergent to the card flow. Other embodiments also contain a conveyor that contains friction and is used to pull the cards through the rollers, and slide whose proximal end prevents the cards from being pulled in the same direction as the web.

Those skilled in the art to which the invention pertains may make other modifications and embodiments employing the principals of this invention without departing from its spirit or essential characteristics, particularly upon considering the foregoing teachings. The described embodiments are to be considered in all respects are only illustrative and not restrictive.

What is claimed is:

1. A method for manufacturing of a plurality of cards from a web comprising the steps of:
feeding a continuous web into a system for manufacturing cards, wherein said system contains a planar surface upon which said web travels,
cutting a plurality of cards from said web via a patterned die whereby said die cuts cards of uniform size, and said cards and web form a web-card matrix, and
separating said cards from said web, whereby said cards continue along said planar surface, and said web is pulled in a divergent direction away from said planar surface.

2. The method of claim 1, further comprising printing indicia upon said cards with at least one printing device.

3. The method of claim 2, further comprising applying a magnetic stripe upon said cards using a heat press.

4. The method of claim 3, further comprising introducing said web made from paper or paperboard.

5. The method of claim 4, wherein the step of separating said cards from said web comprises rollers that pull said web in a divergent direction away from said planar surface.

6. The method of claim 5, wherein the step of separating said cards from said web involves using tension and compressive force to pull said web at a direction divergent from said planar surface.

7. The method of claim 6, wherein the step of separating said cards from said web involves turning said web in a direction approximately ninety degrees from said planar surface.

8. The method of claim 7, further comprising requiring said web having a thickness of approximately 0.25 inches.

9. The method of claim 8, further comprising shingling said cards into a line, wherein shingling eliminates as much slag as possible within the cards.

10. The method of claim 9, further comprising packaging said cards, comprising transporting said cards into boxes, and stacking said cards in said boxes, whereby said boxes are prepared for packaging.

11. The method of claim 10, further comprising stripping additional waste off said web before said web is separated from said cards, wherein the step involves ensuring that said cards do not contain any web by-product.

12. A system for in-line manufacturing of a plurality of cards from a web, comprising of:
a feeder for introducing a continuous web into a system for forming cards,
a planar platform for conveying said web through said system,
a printer that receives said blank web from said feeder and prints a plurality of indicia in a pattern on one side of said web, wherein the pattern represents a plurality of cards,
a dicer that receives said printed web from said printer and cuts a plurality of cards from said web such that said cards remain disposed within said web, and form a web-card matrix,
a separation unit wherein the separation unit directs said web in a divergent direction from said planar platform, and directs said cards in the same plane as said planar platform, separating said web from said cards.

13. The system of claim 12, further comprising a magnetic stripe feed that applies magnetic stripes to said web in a periodic manner by using a heat press.

14. The system of claim 13, further comprising a second printer for printing a plurality of indicia on the other side of said web.

15. The system of claim 14, wherein said separation unit comprises of a card transportation element that receives said cards from said web and transports said cards away, wherein the transportation element comprises at least one roller disposed spatially from the separation unit.

16. The system of claim 15, wherein upon separation, said transportation unit comprises a card securing sheet or plane, the proximal end of which prevents the card from traveling in the same direction as said web.

17. The system of claim 16, wherein said transportation unit consists of a conveyor, slide, rollers, and any such separating units.

18. The system of claim 17, wherein the proximal end of said transportation unit lies above the axis of said rollers.

19. The system of claim 14, wherein said separation unit comprises of rollers that create a compressive force upon said web causing said web to turn in a direction divergent from the direction of said planar platform, whereby said rollers direct said cards onto a conveyer.

20. The system of claim 19, wherein said rollers are arranged in a manner that a first roller is on top of said web-card matrix, and a second roller is below said web-card matrix, whereby said first roller has limited frictional contact with said matrix, and said second roller has sufficient frictional contact to cause said web to be directed in a divergent direction away from said planar platform.

21. The system of claim 20, wherein said conveyor is spaced less than one card length axially from said rollers and contains sufficient friction to assist said cards in being pulled along said conveyor.

22. The system of claim 20, wherein a third roller is positioned along the same axis as said first roller, whereby the spacing from the axial center of said first roller and the axial center of said third roller is less than one card length, and said third roller assists in directing said web in a divergent direction from said planar platform.

23. The system of claim 14, further comprising a shredding unit used to dispose of said web.

24. The system of claim 23, further comprising said web made from paper.

25. The system of claim 24, wherein said web has a thickness of approximately 0.25 inches.

26. The system of claim 25, wherein the cards are maintained on the planar path and sent to be stacked.

27. The system of claim 26, further comprising a stripping unit to ensure that said cards are stripped of any excess web by-product.

28. The system of claim 27, further comprising boxes used to stack said cards.
